(19) United States
(12) Patent Application Publication
(10) Pub. No.: US 2002/0040311 A1
(43) Pub. Date: Apr. 4, 2002

(54) Web browser page rating system

(76) Inventors: John Douglass, Bendigo (AU); Nathan Martyn, Bendigo (AU); John Moetteli, Geneva (CH)

Correspondence Address: Mr. John Moetteli, Case Postale 486, Geneva 12, CH-1211, CH

(21) Appl. No.: 09/970,812

(22) Filed: Oct. 4, 2001

Related U.S. Application Data
(60) Provisional application No. 60/237,510, filed on Oct. 4, 2000.

(51) Int. Cl. G06F 17/60

(52) U.S. Cl. 705/7

(57) ABSTRACT

A computerized web page rating method encoded on a computer-readable medium is provided. The method operates client-side in network browser software, rating the relevancy of web pages visited in a project-based browsing network research session. The ratings of web pages are calculated using a relevancy algorithm selected from a group of algorithms consisting of (1) the application of a rating style or formula to user-defined keywords previously saved in association with a project and (2) manual rating based on visual review of the contents of the web page.

### STATEMENT OF RELATED APPLICATIONS

This application claims priority to U.S. Provisional Application No. 60/237510, the content of which is incorporated herein by reference thereto.

### FIELD OF THE INVENTION

This invention relates to web page rating routines, and more particularly, rating routines for ascertaining the relevance of a particular Internet web page to a research theme.

### BACKGROUND OF THE INVENTION

The abundance of information on the web has given rise to a myriad of search engines. Most, if not all, search engines return search results in order of relevancy given the submitted keywords. Each search engine determines the relevancy of a page given a number of criteria. While this assists the user in locating the information he is looking for, there are limitations when applied to session-based, theme-based, or project-based browsing (project-based browsing is a method of browsing described in PCT/US00/17409, the content of which is hereby incorporated herein by reference). Some of these limitations include the followings:

(a) The relevancy of pages using conventional solutions can not be viewed by supervising members of a project, session, or theme;

(b) There is a lack of detailed information regarding the frequency and location of matched keywords,

(c) A user can submit arbitrary keywords to the search engine thus potentially causing the user to lose focus and become distracted when non-project-, theme- or session-related search engine results are returned;

(d) Due to the demands placed on search engines and the large numbers of pages requiring indexing (for rating purposes), indexing information can quickly become obsolete due to changes in the original page. Moreover, it can take months/days/hours for a search engine to index a web page

The ability to draw a user's attention to matched keywords was implemented in Microsoft Developer Network Service (MSDN) and the Google search engine (www.google.com<http://www.google.com>), where keyword matches are highlighted. The MSDN keyword utility, however, is implemented into the on-line browsing of Microsoft's software development documents, and searches an archive or multiple documents, ordering them relatively. An absolute rating for each matched document is not provided. Both are implemented on the server-side. Neither integrates such features into a web browser. Neither is project based.

Therefore, what is needed is a rating method that rates pages that a user views using a browser, the rating being a reliable indication of the relevancy of the pages viewed in relation to selected projects, themes, or sessions.

### SUMMARY OF THE INVENTION

A computerized web page rating method encoded on a computer-readable medium is provided. The method operates client-side in network browser software, rating the relevancy of web pages visited in a project-, theme- or session-based browsing network research session (herein, use of the term “projects” is to be construed as referring as well to themes or sessions, or theme-, or session-based, as the case may be). The ratings of web pages are calculated using a relevancy algorithm selected from a group of algorithms consisting of (1) the application of a rating style or formula to user-defined keywords previously saved in association with a project and (2) manual rating based on visual review of the contents of the web page.

Further, detected keywords are used to rate each web document visited in real-time. This rating is based on the currently selected rating style, from which there are several to choose from. Each rating style are similar to those used by actual search engines to retrieve web documents given a list of keywords. Each rating style will rate a Web page or downloaded document (such as an HTML document or a text file) based on a series of criteria to determine the “relevancy” in relation to the keywords and thus the project. Therefore, the higher the rating, the more relevant a particular page may be to a project.

### BRIEF DESCRIPTION OF THE DRAWINGS

FIG. 1 is a flowchart of the method of the invention.

FIG. 2 is a screen shot of the Project Properties Dialog of the invention.

FIG. 3 is a schematic diagram of the invention.

FIG. 4 is a screen shot of the Keyword highlighting feature of the invention.

FIG. 5 is a screen shot showing the manual rating feature of the invention.

FIG. 6 is a screen shot of a listing of documents rated by the method of the invention.

### DETAILED DESCRIPTION OF THE PREFERRED EMBODIMENT

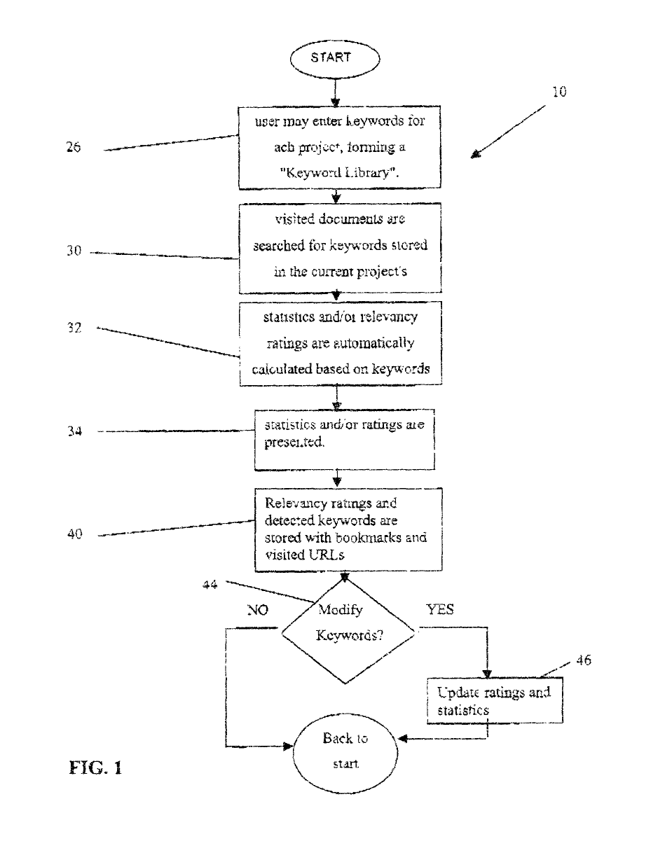

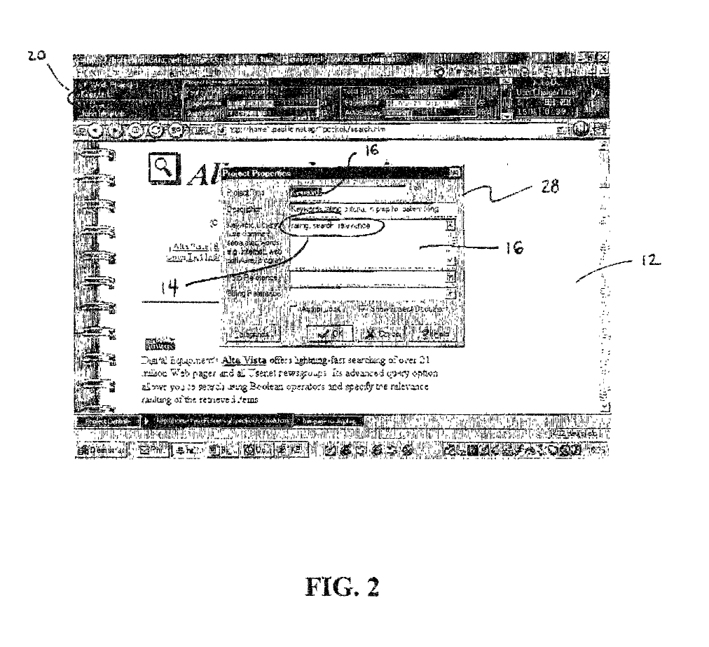

Referring now to FIGS. 1 and 2, a computerized method 10 encoded on a computer-readable medium is provided which automatically rates web pages 12 based on pre-designated, project-based keywords 14 during research in which results are saved in association with a project 20. In FIG. 2, the general inputs solicited of the user upon the definition of a project 20, are shown. This method 10 allows a “Keyword Library” 16 to be associated with a project 20 upon project creation (and optionally modified during project execution), whereby the keywords 14 are used to search each visited document 12. The method 10 also provides users with the ability to quickly view and locate project keywords 14 in the current page when browsing.

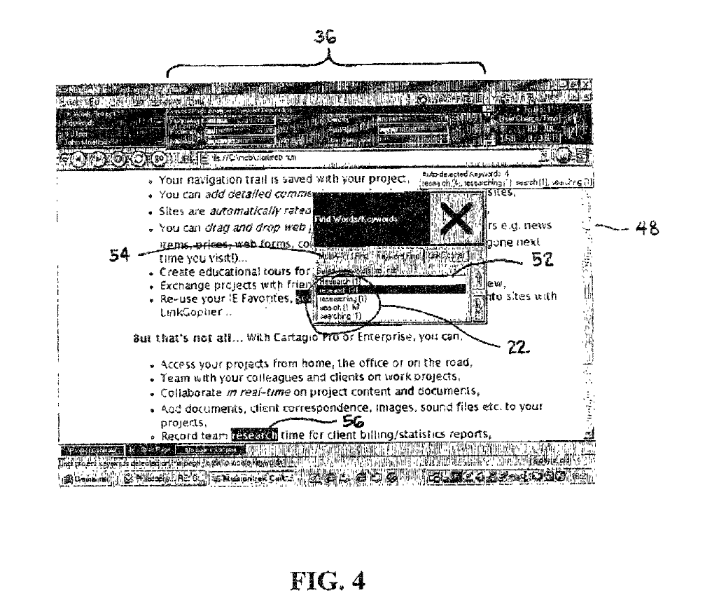

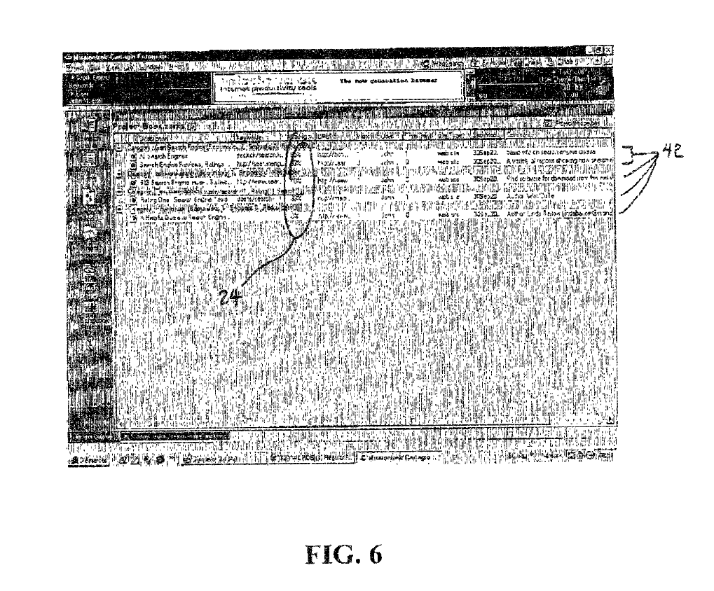

Further, detected keywords 22 (shown in FIG. 4) are used to rate each web document 12 visited in real-time. This rating 24 (shown in FIG. 6) is based on the currently selected rating style, from which there are several to choose form (described in more detail below). Each rating style is similar to those used by actual search engines to retrieve web documents given a list of keywords. Each rating style will rate a Web page based on a senes of criteria to determine the “relevancy” in relation to the keywords and thus the project. Therefore, the higher the rating 24, the more relevant a particular page 12 may be to a project 20.

The method 10 includes the following steps. In a first step 26, a user enters keywords 14 (including provision for whole-word matches and case-sensitivity) into a Project Properties Dialog 28 for the project 20 associated with a client or theme (such as “Keywords” 20), thus forming a “Keyword Library” 16 which is saved in association with the PBB file. In a second step 30, the words(s), phrase(s) or symbol(s) of visited documents 12 such as HTML, text, and XML pages (including such documents non-visible text such as meta-tags, URLs and email addresses) are scanned for words, phrases or symbols that match keywords 14 stored in the current project's Keyword Library 16. In a third step 32, a computer processor (on a PC on which the software is running) applies calculation logic stored in the method 10 to automatically calculate statistics and/or relevancy ratings 24 based on keywords 14 found in the document 12 (using algorithms for frequency, location, density, proximity, Autorank and matches, for example). In an optional fourth step 34, statistics and/or ratings 24 are presented in visual form, such as in via bar graph display 36 (shown in FIG. 4). In a fifth step 40, relevancy ratings 24 and detected keywords 22 are stored as in a data field of a bookmark structure 42 (shown in FIG. 6) which includes visited URLs, and they may at any time be viewed or sorted/ordered based on a selected ratings style. For example as shown in FIG. 6, the bookmark structure 42 is organized by descending relevancy. Thus, users are provided with the tools to re-visit, find, and refer to documents that are more relative to the project at hand. In an optional sixth step 44, the user may re-display the Project Properties Dialog 28 and modify the keywords 14. In an optional seventh step 46, if a modification is made, ratings and statistics are automatically recalculated and updated in the bookmark structure 42 based on the latest contents of the keyword library 16.

In the fourth step 34, statistics may be presented in six or more ratings styles (including a custom system), each providing visited documents with a rating between 0 and 100% (e.g., ratings 24 of FIG. 6). These ratings styles reflect the relevancy of visited web documents 12 to the current project 20. At any point, users may change their selection of a ratings style (by for example, right clicking the rating 24 and selecting from a menu of rating styles, to view updated ratings for displayed bookmarks and URLs. A mix or ratings styles maybe selected for similarity with the (unpublished) ratings mechanisms of several popular search engines (Alta Vista, Excite, Hotbot, Infoseek and Lycos).

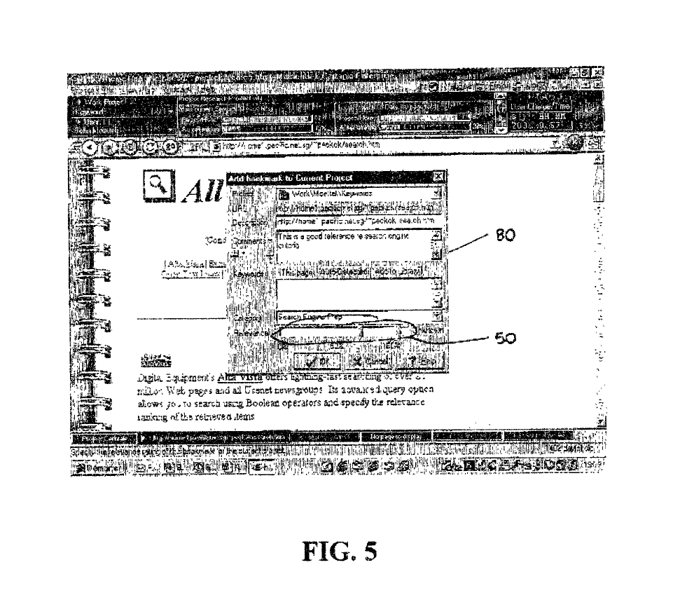

Referring now to FIG. 5, in a feature of the invention, when bookmarking a page, users can optionally extend the existing project keyword library 16 with additional terms.

In another feature of the invention, users have the ability to optionally specify their own rating 50 of how relevant a URL is to a project 20 when bookmarking or revisiting a bookmarked page.

Referring no to FIG. 4, a screen shot of a browser GUI 48 is shown displaying a sample web page 12 visited during a project-based browsing research session. Users may at any time view the auto-detected keywords 22 in a document 12 through any of three or more ways, 1) via a hint activated caption 52 displaying all matches found and frequencies; 2) via a custom find dialog accessible through clicking on the find tab 54; 3) via a navigation history and/or bookmark list, such as that shown in FIG. 6, where auto-detected words and ratings are stored for each URL visited.

In the first means for viewing auto-detected keywords 22, the caption 52 displays auto-detected keywords in a document 12, each keyword 14 matched being displayed alongside the frequency it occurred and an indication of whether the keywords are visible or not (the fact that a keyword is hidden may be noted with the symbol “h”, after the number representing the frequency). Any selection of keywords 14 may be made, whereby only those selected are searched for, the selected keyword being highlighted in red 56 or italicized. This feature allows users to efficiently navigate to the location of found keywords 22 in a document 12, enabling a quicker assessment of its relevancy. To further make keywords easier to locate, each match is highlighted with, say, a black background, enabling quick identification of relevant sections even when scrolling through the document, thus eliminating having to read every word.

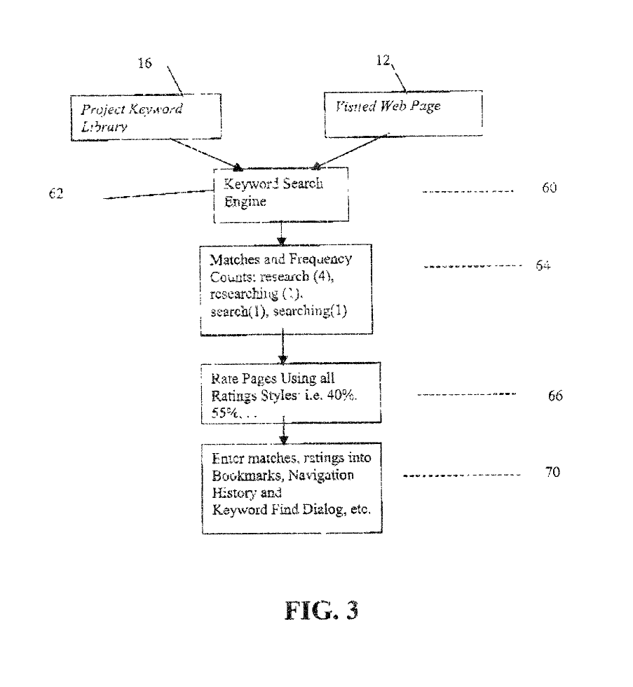

Referring now to FIG. 3, a schematic of the method 10 of the invention is shown. In a first step 60, the keyword library 16 and the contents of the visited document 12 are input into a keyword search engine 62. In a second step 64, the number of matches and frequency counts are calculated. In a third step 66, the visited pages 12 are rated using a variety of rating styles. In a fourth step 70, the matches and ratings are made available for display at the command of the user, the user being able to define the rating style for the rating of the visited page 12.

Each of the rating styles supported are loosely derived from actual search engines used by World Wide Web users to retrieve Web documents given keywords. Each factor considered when rating a page is defined below (the following not intended to provide a complete list of factors, only the more important ones).

Meta-data: Indicates that the rating system searches meta-data of a Web page. A Web page will rank higher if any keywords specified occur in any of this data (i.e., URL, Tile & Meta-tags).

Frequency: Indicates that the rating system takes into consideration the number of times each keyword appears in a document. Therefore, the greater frequency of a keyword, the higher the rating.

Matches: Indicates that the rating system takes into consideration the number of keywords that were located in a document. Therefore, the greater number of keywords that were found at least once, the higher the rating.

Proximity: Indicates that the rating system takes into consideration the proximity (closeness) of located keywords in a document. Therefore, the closer the matched keywords, the higher the rating.

Density: Indicates that the rating system takes into consideration the number of keywords matched in relation to the document size. Therefore, a page which contains an equal number of matched keywords will receive a higher rating than another if the size of the page is smaller—thus a greater density.

Referring now to FIG. 5, in an alternate embodiment of the invention, the method 10 provides the user with a bookmark interface 80, displayed through clicking the displayed page 12 to ranked with the right mouse button. This interface 80 allows the user to override any manual relevancy calculation by inputting a manual relevancy via, for example, the slide bar 50. Thus, the method 10 of the invention allows users to view projects ranked objectively, using a relevancy algorithm or subjectively, using a manually set ranking as shown in this figure. The manually set ranking may be of more value to the extend that those that are setting the ranking have experience or can more effectively assess the true relevancy of a particular web resource.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A computerized method encoded on a computer-readable medium, the method operating client-side in network browser software, the method rating the relevancy of a downloaded document visited in a project-based network research session, the relevancy ratings determined being saved in association with the downloaded document, wherein the relevancy ratings are determined using a relevancy method selected from a group of methods consisting of (1) scanning for keywords present in the viewed downloaded document which match keywords stored in a project-based keyword library followed by the application of a rating style or formula to user-defined keywords of a keyword library previously saved in association with a project and (2) manual rating based on a visual review of the contents of the downloaded document.

2. The method of claim 1 wherein detected keywords found in the downloaded document are automatically highlighted or italicized.

3. The method of claim 1 wherein detected keywords are used to rate each downloaded document in real-time.

4. The method of claim 1 wherein the rating style or formula is selected from a group of styles or formulas consisting of (a) those used by actual search engines Alta Vista, Excite, Hotbot, Infoseek and Lycos; (b) a custom rating style; (c) simple keyword number count ratings optionally apply statistical weighting factors; (d) meta-data, (e) frequency; (f) matches; (g) proximity; (h) density; and (i) Autorank.

5. The method of claim 1, wherein the users can edit the existing project, theme, or session keyword library by adding additional terms or deleting existing terms, during such actions as bookmarking.

6. The method of claim 1 wherein the method includes relevancy specifying means which a user specified according to his own rating of relevancy of an URL to a project when bookmarking or revisiting a bookmarked page.

7. The method of claim 6 wherein the means is a slide bar.

8. The method of claim 1 wherein the method includes means for viewing the auto-detected keywords in a document.

9. The method of claim 8, wherein the means is selected from a group of means consisting of (a) a caption displaying all matches found and frequencies, (b) a custom find dialog and (c) a navigation history and bookmark list in which auto-detected words and ratings are stored for each URL visited.

10. The method of claim 1 wherein a custom find dialog is provided which allows the user to locate auto-detected or user input keywords in the downloaded document.

11. The method of claim 1, wherein display means is provided for displaying a distribution of keywords within each downloaded page in graphical form.

12. The method of claim 11, wherein locating means is provided which, by clicking on a detected keyword, the web page is automatically scrolled to display that keyword in highlighted form.
